(19) United States
(12) Patent Application Publication
(10) Pub. No.: US 2016/0012013 A1
(43) Pub. Date: Jan. 14, 2016

(54) SCALED JACOBIAN VECTORS AND SKETCHING CONSTRAINTS

(71) Applicant: SIEMENS CORPORATION, Iselin, NJ (US)

(72) Inventor: Richard Gary McDaniel, Hightstown, NJ (US)

(21) Appl. No.: 14/769,018

(22) PCT Filed: Feb. 18, 2014
(86) PCT No.: PCT/US2014/016802

§ 371 Date: Aug. 19, 2015

Related U.S. Application Data
(60) Provisional application No. 61/766,247, filed on Feb. 19, 2013.

(51) Int. Cl. G06F 17/16

(52) U.S. Cl. CPC G06F 17/16

(57) ABSTRACT

According to an aspect of the disclosure, there is provided a method for solving sketching constraints that includes isolating (11) a set of sketching constraints into groups of constraints with related variables, checking (14) a magnitude of error in a group of constraints, and reducing (16) the error magnitude by applying a scaled Jacobian method, if the error magnitude is too high, where if (17) the error magnitude is still too high after applying the scaled Jacobian method, selecting and removing (18) a constraint from the group of constraints.

### CROSS REFERENCE TO RELATED UNITED STATES APPLICATIONS

This application claims priority from “Using Scaled Jacobian Vectors to Resolve Sketching Constraints”, U.S. Provisional Application No. 61/766,247 of Richard McDaniel, filed on Feb. 19, 2013, the contents of which are herein incorporated by reference in their entirety.

### TECHNICAL FIELD

Embodiments of the present disclosure are directed to solving constraints generated as part of a process for beautifying hand drawn geometry.

### DISCUSSION OF THE RELATED ART

Hand-drawn geometry can arise from numerous contexts. A common source is from pen, touch, and video input devices such as tablet computers, electronic whiteboards, and camera recognition input. The means for providing the input is filtered to convert the input into lines, curves, surfaces, or other geometric figures that can be recognized by the device. For example, the path of a pen input stroke is converted into a curve. Further processing converts the geometric figure into parametric entities. For example, the curves may be merged into continuous sections and then Bezier curves may be fit to represent them. The geometric figure then can undergo beautification in which lines are made straight, lengths made equal, circular arcs are made into perfect circles, arcs are made concentric, angles are made equal, angles made perpendicular, lines made parallel, and other possibilities.

Beautification can use a constraint search technique to determine possible commonalities and symmetries between geometric entities. A beautification system may search for approximate relationships, such as lines appearing parallel because they are joined at the same point and seem to be a tangent continuation of the same curve. The system may find many possible constraints. The constraints may be redundant. For example, the system may find that a line is parallel to a world axis and it may find that it is also parallel to another line and it may find that the other line is also parallel to the same world axis. These three parallel constraints are redundant because choosing any two to solve will cause the third to be true. In practice, actual redundant loops of constraints may be more complicated.

In this use case, a user does not choose which constraints to apply. Therefore, redundant, over-constrained, and under-constrained systems of constraints may be likely to appear. This use case also implies that the variables used to solve constraints may be numerous, but that many will have little or no effect. For example, if the geometry comprises a single line drawn horizontally, the system may move either end point up or down or left or right if it is restricted to two dimensions, to make the line more horizontal and solve a parallel to world axis constraint. This can provide four degrees of freedom, two for each of the two end points, but the constraint only removes one degree of freedom leaving the other three variables free.

The fundamental constraints can be equality tests based on taking the difference between corresponding values on two vectors. The absolute quantity of this difference can be treated as the error in the constraint. If the two quantities are equal, the error would be zero. When all the constraints are zero, then there would be no error and the constraints are considered solved. In principle, actually reaching zero error may not be called for and reducing the error to a small threshold value is sufficient. In this case, one is evaluating how closely the evaluations of the constraints match up. If the functions being compared by the constraint were completely equal, the error would be zero. But usually, the evaluations do not match, and produce some difference. These differences can be weighted and summed up to obtain a numerical global error metric. The system may use the absolute value of the scaled sum of error values of the constraints to perform this test. It is desirable to make the error value smaller, or at least not larger. When the error is lower, the constraints are more likely to be equal producing results that match the desired constraint properties.

The constraints can form comparisons on pairs of values. These values, in turn, can be provided using procedural or formulaic methods. The system may define a formula on vector, point, and scalar values. A beautification system may define vectors and points in multiple dimensions. Typically, two dimensional or three dimensional values can be used. The constraints also may have the same dimensionality of the values used as input.

A beautification system may vary the position of the geometric elements to satisfy the constraints. The geometry the system chooses to represent the user's hand drawn ink polyline can be placed initially in a 2D or 3D position such that its 2-dimensional projection is proximal to where an original ink polyline is drawn. For example, two end points may form the basis of a line geometric object. A circular geometric arc object may be designated by a center point, and a start and end point where the arc meets other geometry. Varying the position of either or both end points of the line object may change whether or not the line is co-located with another geometric object, is centered in another object, or has a particular angular aspect such as being parallel. Procedural or formulaic methods may be used to transform the points on geometric objects to constrained values. For example, a distance operation may be performed on the start point of a circular arc geometric object with its center point to find the radius as a scalar. The same operation may be performed with its end point to also find the radius. A constraint may be formed between the two radii formulae to say that the radius of a circle has the same scalar value.

A Jacobian method for solving constraints is a blind method that treats the functions being solved as black-box entities. The premise of a Jacobian method for solving constraints is to find the gradient of an error function with respect to the variables being solved. The method then uses a hill-climbing approach to reduce the error by following the slope of the gradient. A Jacobian method can evaluate the constraint error functions for a given set of input variables, without inverting the functions themselves. A Jacobian method runs step by step attempting to reduce the overall error computed by the constraints in each iteration. To support interactive editing, a constraint system should be relatively quick and converge in a small number of steps.

### SUMMARY

Exemplary embodiments of the disclosure as described herein generally include systems and methods for solving a set of constraints that results from inferring relationships in hand-sketched geometry by applying scaling factors to the constraints to prevent undesirable results. Embodiments of the present disclosure can be incorporated into 3D sketching projects that can quickly and easily draw a 3D model.

According to an aspect of the disclosure, there is provided a method for solving sketching constraints that includes isolating a set of sketching constraints into groups of constraints with related variables, checking a magnitude of error in a group of constraints, and reducing the error magnitude by applying a scaled Jacobian method, if the error magnitude is too high, where if the error magnitude is still too high after applying the scaled Jacobian method, selecting and removing a constraint from the group of constraints.

According to a further aspect of the invention, the method includes, after removing a constraint, applying the scaled Jacobian method to the remaining constraints to reduce the error magnitude.

According to a further aspect of the invention, selecting a constraint to be removed from the group of constraints includes at least one of determining which constraints have a highest error and choosing those constraints within a predetermined range of the highest error, selecting those constraints that share a variable with a constraint with the highest error, and using a weighting criteria to eliminate constraints.

According to a further aspect of the invention, applying a scaled Jacobian method includes finding, for all constraints in the group, a constraint with a highest error, normalizing the other constraint errors to the constraint with the highest error by calculating a multiplier for each variable in the constraints based on a relative error size of each constraint, where the highest error has a multiplier weight of one, initializing an increment size for all variables, and calculating a variable increment size that reduces a constraint error and determining a scaling factor from a multiple of that increment that maximizes error reduction, while the error size is greater than a predetermined threshold and there exist non-zero increments.

According to a further aspect of the invention, the method includes applying the scaling factor to a Jacobian vector of the constraint variables to determine a greatest error that can be eliminated, and applying the Jacobian vector to the variables to reduce the constraint error.

According to a further aspect of the invention, calculating a variable increment size that reduces a constraint error includes selecting active variables for which error reduction will be calculated, initializing an increment step for an active variable, determining if a current increment value will increase or decrease the error for an active variable, and halving the increment size, if the current increment docs not decrease the error, or using the current increment as a step direction for the corresponding active variable.

According to a further aspect of the invention, calculating how much a constraint error changes for a given incremental value comprises using a scaled error approach.

According to a further aspect of the invention, the method includes, if at least one variable causes the error to decrease, using a Jacobian vector for all variables that decrease the error to reduce the constraint error.

According to a further aspect of the invention, selecting variables to be active further includes initializing a contribution to error reduction for each constraint variable by using the current increment value, determining a magnitude of change in the constraint error for all variables, and marking a variable with a least contribution as being inactive, where a number of degrees-of-freedom for the variables is reduced by the number of degrees-of-freedom for the inactivated variable, where the steps of determining a magnitude of change and marking a variable are performed while the number of degrees-of-freedom for the variables is greater than the number of degrees-of-freedom for the constraints.

According to another aspect of the disclosure, there is provided a method for solving sketching constraints that includes isolating a set of sketching constraints into groups of constraints with related variables, checking a magnitude of error in a group of constraints, where if the error magnitude is too high, the method includes reducing the error magnitude by applying a scaled Jacobian method by calculating a variable increment size that reduces a constraint error, and determining a scaling factor from a multiple of that increment that maximizes error reduction, applying the scaling factor to a Jacobian vector of the constraint variables to determine a greatest error that can be eliminated, and applying the Jacobian vector to the variables to reduce the constraint error, while the error size is greater than a predetermined threshold and there exist non-zero increments.

According to a further aspect of the invention, if the error magnitude is still too high, the method further comprises selecting and removing a constraint from the group of constraints, and applying the scaled Jacobian method to the remaining constraints to reduce the error magnitude.

According to a further aspect of the invention, the method includes finding, for all constraints in the group, a constraint with a highest error, and normalizing the other constraint errors to the constraint with the highest error by calculating a multiplier for each variable in the constraints based on a relative error size of each constraint, where the highest error has a multiplier weight of one.

According to a further aspect of the invention, calculating a variable increment size that reduces a constraint error includes selecting active variables for which error reduction will be calculated, initializing an increment step for an active variable, determining if a current increment value will increase or decrease the error for an active variable, halving the increment size, if the current increment does not decrease the error, or using the current increment as a step direction for the corresponding active variable, and if at least one variable causes the error to decrease, using a Jacobian vector for all variables that decrease the error to reduce the constraint error.

According to a further aspect of the invention, selecting variables to be active further includes initializing a contribution to error reduction for each constraint variable by using the current increment value, determining a magnitude of change in the constraint error for all variables, and marking a variable with a least contribution as being inactive, where a number of degrees-of-freedom for the variables is reduced by the number of degrees-of-freedom for the inactivated variable, where the steps of determining a magnitude of change and marking a variable are performed while the number of degrees-of-freedom for the variables is greater than the number of degrees-of-freedom for the constraints.

According to another aspect of the invention, there is provided a non-transitory program storage device readable by a computer, tangibly embodying a program of instructions executed by the computer to perform the method steps for solving sketching constraints.

### BRIEF DESCRIPTION OF THE DRAWINGS

FIG. 1 is a flow chart of a top level method for solving constraints according to an embodiment of the disclosure.

FIG. 2 is a flow chart of a method for applying a scaled Jacobian approach to a given set of constraints, according to an embodiment of the disclosure.

FIG. 3 is a flowchart of a binary search method for determining the amount of change to be applied to each variable, according to an embodiment of the disclosure.

FIG. 4 is a flowchart of a method for selecting variables to be active, according to an embodiment of the disclosure.

FIG. 5 is a block diagram of an exemplary computer system for implementing a method for using scaled Jacobian vectors to resolve sketching constraints, according to an embodiment of the disclosure.

### DETAILED DESCRIPTION OF EXEMPLARY EMBODIMENTS

Exemplary embodiments of the disclosure as described herein generally include methods for using scaled Jacobian vectors to resolve sketching constraints. Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

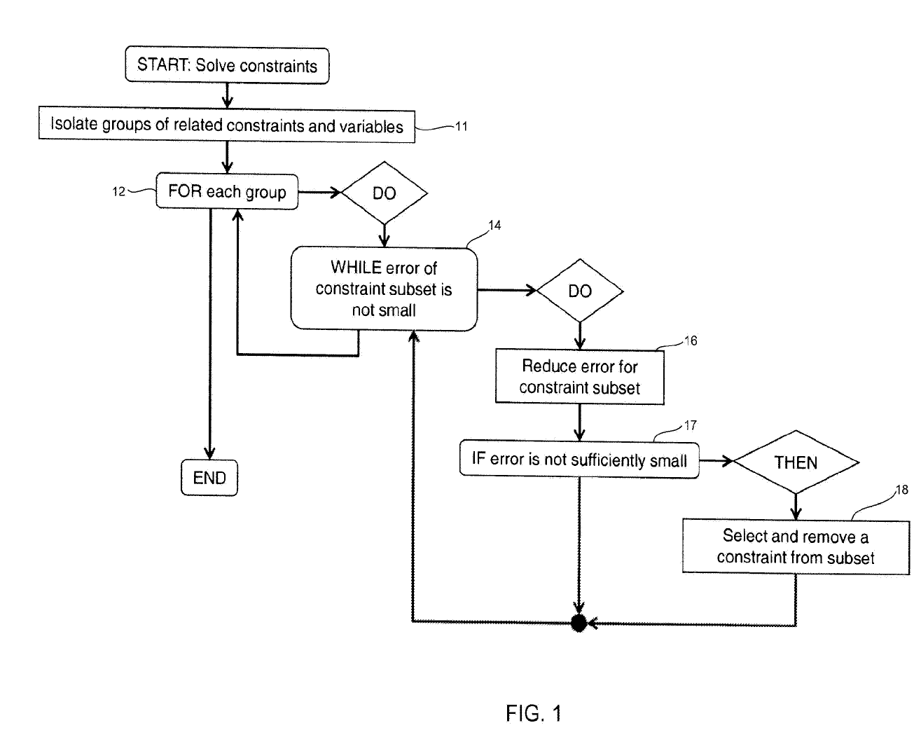

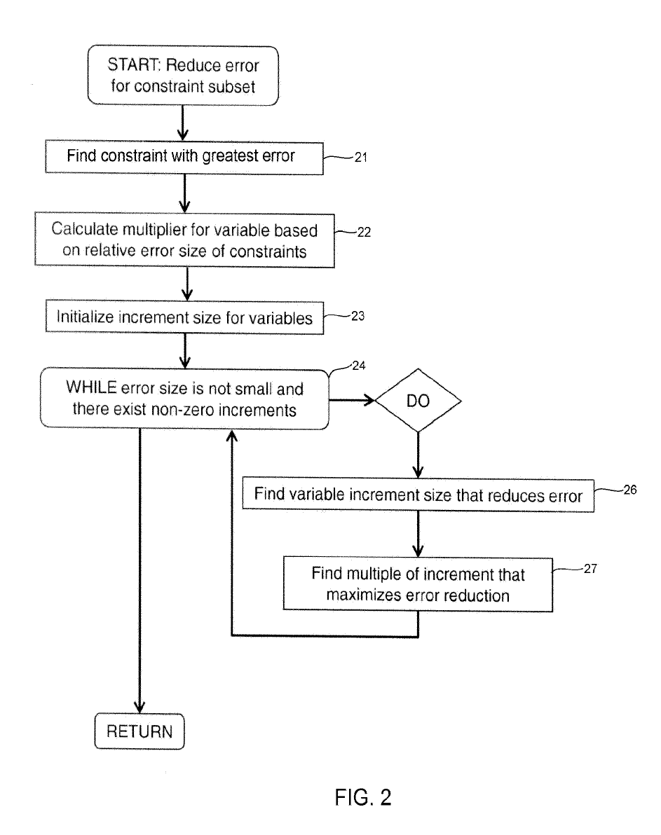

FIG. 1 is a flow chart of a top level method for solving constraints according to an embodiment of the disclosure. A method begins at step 11 by isolating the constraints into groups of constraints with related variables. The constraints can be separated into independent groups by following the links in their formulas to their set of variables. The constraints can be represented by graphs, and links in the graphs can be searched by a standard graph search algorithm, such as depth-first search. All constraints that share a variable may be formed into the same group. Because each group is independent, the error for the constraints in that group can be resolved independently or even in parallel. The FOR-WHILE loop level of steps 12 and 15 checks the magnitude of error in a given group of constraints. If, at step 14, the error of a constraint group is less than a predetermined threshold, the method returns to step 21 to check the next constraint group. Otherwise, if the error is too high, the error is reduced at step 16 through a scaled Jacobian method. An exemplary, non-limiting scaled Jacobian method according to an embodiment of the disclosure is described in greater detail with reference to FIG. 2, below. If, at step 17, the error is still too high after the method is applied, it can be assumed that there are conflicting constraints preventing the method from making progress. Then, at step 18, a constraint from the group is selected as being the one preventing progress and removed, and the scaled Jacobian method is applied to the remaining constraints. The WHILE loop of step 14 repeats until the desired error is sufficiently small.

A criteria according to an embodiment of the disclosure for eliminating a constraint can be manifold. An exemplary method can determine which constraints have the highest error after error reduction has completed and can choose among them for one to eliminate. One exemplary, non-limiting criteria is for a beautification system according to an embodiment of the disclosure to choose those constraints within some range of the highest remaining error. For example, constraints whose error is at least 50% as much as the highest error may be selected for consideration. Other criteria may be used, such as selecting those constraints that share a variable with the constraint with the highest error. According to an embodiment of the disclosure, a constraint dependent method may be applied to select a constraint to eliminate from the set of those being considered. For example, if the constraints are based on taking the end points of two geometric objects and bringing them together as one point, the constraint whose end points were furthest apart when the user first drew the geometry may be selected as the one to eliminate. According to other embodiments of the disclosure, a weighting criteria may be used to eliminate constraints. For example, if a constraint that determines angles is considered against a constraint that compares position, the position constraint may be favored with a higher weight because it may be assumed that the user can perceive the position of a geometric object better than judging the angle of a geometry object.

FIG. 2 is a flow chart of a method according to an embodiment of the disclosure for applying a scaled Jacobian approach to a given set of constraints. A Jacobian-based method can determine an incremental change of values for the input variables that causes the overall error of the constraints to decrease. Starting with an initial seed value for all the variables, the values are repeatedly modified until the error is reduced to an acceptably small value or the amount of change that can be applied to the error becomes too small to be effective.

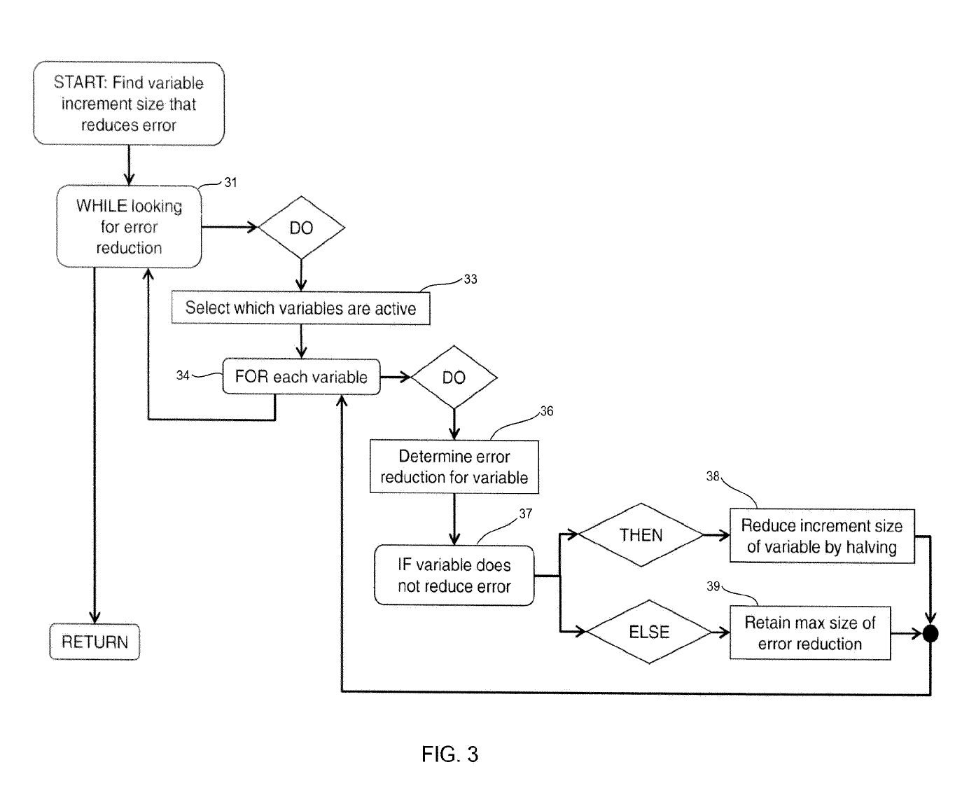

A method according to an embodiment of the disclosure uses the size of the error to determine how much emphasis each input variable gets when it is used to reduce the error. Constraints with a highest error may receive the most emphasis while those with a small error may have their variables kept constant. A Jacobian method according to an embodiment of the disclosure may begin, at step 21, by finding, for all constraints, the constraint with the highest error. The other constraint errors may be normalized to this value at step 22 and a multiplier is calculated for each variable based on the relative error size of the constraints. The highest error may be given a multiplier weight of one and a multiplier weight of other errors may have values between one and zero inclusive. When calculating a contribution to the error by a given increment to a variable, these multiplier weights may be used to determine how much help that change will make. When a sum of the errors is calculated, the error of each constraint may be multiplied by its weight. By this method, the error can be normalized and constraints with the most error will have the highest contribution to the error sum. A Jacobian method according to an embodiment of the disclosure continues at step 23 by initializing an increment size for all variables, and then loops over all errors in the WHILE loop of step 24. An exemplary, non-limiting WHILE loop is performed while the error size is greater than a predetermined threshold and there exist non-zero increments. In the loop, a variable increment size that reduces a constraint error is calculated at step 26, and a multiple of that increment that maximizes the error reduction is determined at step 27. An exemplary, non-limiting method according to an embodiment of the disclosure for calculating a variable increment size that reduces a constraint error is described in greater detail with reference to FIG. 3, below.

When a difference is taken between the original error and an error after changing a variable, variables that can change a large error constraint can show a bigger difference than variables that affect small error constraints. An error reduction method according to an embodiment of the disclosure can help by holding values steady when they are most effective at keeping errors small and changing those variables that cause constraints to have a large error.

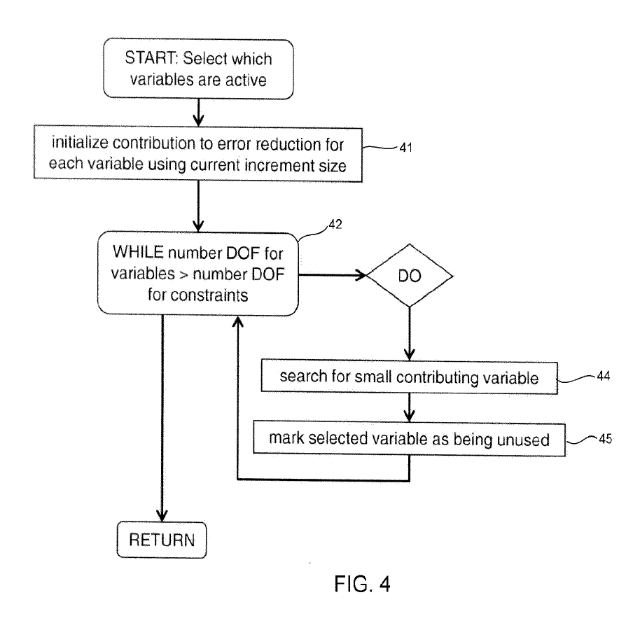

A method according to an embodiment of the disclosure for reducing error initializes an increment step for the variables and applies an increment as much as needed to reduce the error. An increment can be found by a binary search. FIG. 3 is a flowchart of an exemplary, non-limiting binary search method according to an embodiment of the disclosure for determining the amount of change to be applied to each variable. From the outset, it may not be known how much one should change a given variable. Change the variable too little and nothing happens to the error, but change the variable too much and one might overshoot and the error is not reduced at all. A method according to an embodiment of the disclosure may use multiple stages to determine the increment size. A method may begin by looping over all variables from the WHILE statement of step 21 to look for error reduction. At step 33, a method may first select which variables it will use and which ones are deactivated and not changed. An exemplary, non-limiting method according to an embodiment of the disclosure for selecting active variables is described in greater detail with reference to FIG. 4, below. A method may then loop through each selected variable from the FOR statement of step 34 and determine if the current increment value will cause the overall error to increase or decrease. According to an embodiment of the disclosure, a scaled error approach may be used at step 36 to calculate how much a constraint error changes for a given incremental value. If, at step 37, the tested increment does not reduce the error, the size of the increment can be halved at step 38. Otherwise, the tested increment will be maintained at step 39 and may be treated as a minimal value for the step direction for that variable.

If at least one variable causes the error to decrease at step 37, the Jacobian vector for all variables that decrease the error can be used to reduce the constraint error. Those variables whose increments were halved may be kept at their current value by setting their contribution to the Jacobian vector to zero. If no variable increment was found to decrease the constraint error, the WHILE loop of step 31 may be repeated, however, at this stage, all the increments will be smaller. The increments for variables that decreased errors will tend to stay large as long as they continue to improve the error. Other increments are made smaller and smaller to find any contribution the variable might make and to eliminate any overshoot the increment may be causing. If all the increments reduce to a value smaller than a predetermined threshold, then the WHILE loop of step 31 will exit,

Returning to the WHILE loop of step 24 in FIG. 2, the Jacobian vector determined by a half-scaling method according to an embodiment of the disclosure is applied to the variables to reduce the error. A scaling factor is applied to the Jacobian vector at step 27 to determine the greatest error that can be eliminated. The scaling factor may start at one and may be doubled as long as applying the scaled vector reduces errors. When no further error reduction occurs, the scaling factor may be reduced from its last value to a value between the last value and the value that last reduced the error. A binary search between these values may be applied to find a value for the scaling factor that best reduces the constraint error.

One of the steps of FIG. 3, step 33, is to select active variables. As increment values change, different variables may be switched from an active to an inactive state depending on how that variable's increment contributes to the overall error reduction. FIG. 4 is a flowchart of a method according to an embodiment of the disclosure for selecting variables to be active. Assuming at first that all variables may be used, a method according to an embodiment of the disclosure determines the number of degrees of freedom being represented by both the constraints and the variables. Degrees of freedom (DOF) are produced by variables, essentially one degree of freedom for each scalar value, and degrees of freedom are consumed by constraints in the same way. As long as the number of degrees of freedom for the constraints is smaller than the degrees of freedom for the variables, variables can eliminated until the number of variable DOFs matches the number of constraint DOFs

A method according to an embodiment of the disclosure may use, at step 41, the current increment value as determined by the method according to an embodiment of the disclosure shown in FIG. 3. The method then loops over all variables from the WHILE statement of step 42, while the number of degrees-of-freedom for the variables is greater than the number of degrees-of-freedom for the constraints. The size of the change in error is determined for all variables at step 44 and the one with the least contribution are marked as being unused at step 45. The number of degrees-of-freedom for the variables is then reduced by the number of degrees-of-freedom for the deactivated variable.

It is to be understood that embodiments of the present disclosure can be implemented in various forms of hardware, software, firmware, special purpose processes, or a combination thereof. In one embodiment, the present disclosure can be implemented in software as an application program tangible embodied on a computer readable program storage device. The application program can be uploaded to, and executed by, a machine comprising any suitable architecture.

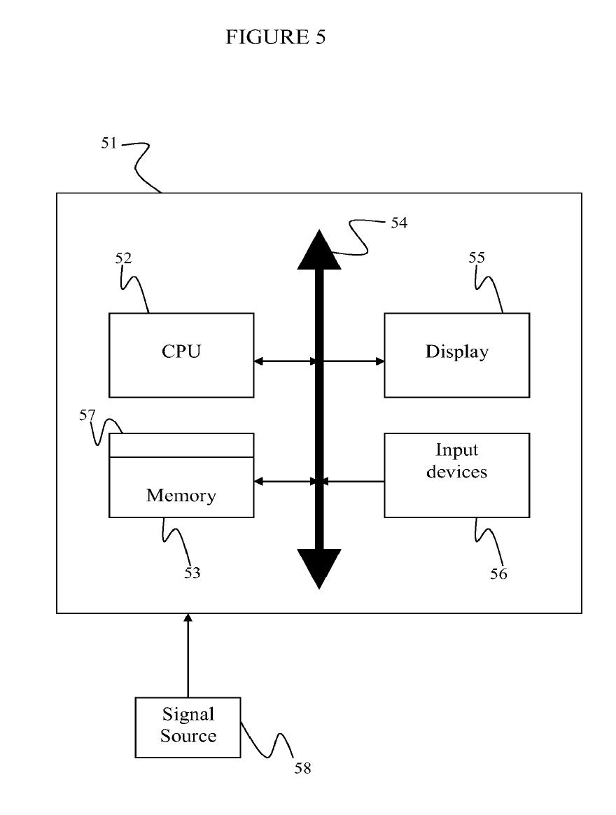

FIG. 5 is a block diagram of an exemplary computer system for implementing a method for using scaled Jacobian vectors to resolve sketching constraints according to an embodiment of the disclosure. Referring now to FIG. 5, a computer system 51 for implementing the present invention can comprise, inter alia, a central processing unit (CPU) 52, a memory 53 and an input/output (I/O) interface 54. The computer system 61 is generally coupled through the I/O interface 54 to a display 55 and various input devices 56 such as a mouse and a keyboard. The support circuits can include circuits such as cache, power supplies, clock circuits, and a communication bus. The memory 53 can include random access memory (RAM), read only memory (ROM), disk drive, tape drive, etc., or a combinations thereof. The present invention can be implemented as a routine 57 that is stored in memory 53 and executed by the CPU 52 to process the signal from the signal source 58. As such, the computer system 51 is a general purpose computer system that becomes a specific purpose computer system when executing the routine 57 of the present disclosure.

The computer system 51 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present disclosure.

While the present disclosure has been described in detail with reference to exemplary embodiments, those skilled in the art will appreciate that various modifications and substitutions can be made thereto without departing from the spirit and scope of the disclosure as set forth in the appended claims.

What is claimed is:

1. A method for solving sketching constraints, comprising:
isolating a set of sketching constraints into groups of constraints with related variables;
checking a magnitude of error in a group of constraints; and
reducing the error magnitude by applying a scaled Jacobian method, if the error magnitude is too high,
wherein if the error magnitude is still too high after applying the scaled Jacobian method, selecting and removing a constraint from said group of constraints.

2. The method of claim 1, further comprising, after removing a constraint, applying the scaled Jacobian method to the remaining constraints to reduce the error magnitude.

3. The method of claim 1, wherein selecting a constraint to be removed from the group of constraints includes at least one of determining which constraints have a highest error and choosing those constraints within a predetermined range of the highest error, selecting those constraints that share a variable with a constraint with the highest error, and using a weighting criteria to eliminate constraints.

4. The method of claim 1, wherein applying a scaled Jacobian method comprises:
finding, for all constraints in the group, a constraint with a highest error;
normalizing the other constraint errors to the constraint with the highest error by calculating a multiplier for each variable in the constraints based on a relative error size of each constraint, wherein the highest error has a multiplier weight of one;
initializing an increment size for all variables; and
calculating a variable increment size that reduces a constraint error and determining a scaling factor from a multiple of that increment that maximizes error reduction, while the error size is greater than a predetermined threshold and there exist non-zero increments.

5. The method of claim 4, further comprising:
applying the scaling factor to a Jacobian vector of the constraint variables to determine a greatest error that can be eliminated; and
applying the Jacobian vector to the variables to reduce the constraint error.

6. The method of claim 4, wherein calculating a variable increment size that reduces a constraint error comprises:
selecting active variables for which error reduction will be calculated;
initializing an increment step for an active variable;
determining if a current increment value will increase or decrease the error for an active variable; and
halving the increment size, if the current increment does not decrease the error, or using the current increment as a step direction for the corresponding active variable.

7. The method of claim 6, wherein calculating how much a constraint error changes for a given incremental value comprises using a scaled error approach.

8. The method of claim 6, further comprising, if at least one variable causes the error to decrease, using a Jacobian vector for all variables that decrease the error to reduce the constraint error.

9. The method of claim 6, wherein selecting variables to be active further comprises:
initializing a contribution to error reduction for each constraint variable by using the current increment value;
determining a magnitude of change in the constraint error for all variables; and
marking a variable with a least contribution as being inactive, wherein a number of degrees-of-freedom for the variables is reduced by the number of degrees-of-freedom for the inactivated variable,
wherein the steps of determining a magnitude of change and marking a variable are performed while the number of degrees-of-freedom for the variables is greater than the number of degrees-of-freedom for the constraints.

10. A method for solving sketching constraints, comprising:
isolating a set of sketching constraints into groups of constraints with related variables;
checking a magnitude of error in a group of constraints,
wherein if the error magnitude is too high, the method includes reducing the error magnitude by applying a scaled Jacobian method by
calculating a variable increment size that reduces a constraint error, and determining a scaling factor from a multiple of that increment that maximizes error reduction,
applying the scaling factor to a Jacobian vector of the constraint variables to determine a greatest error that can be eliminated; and
applying the Jacobian vector to the variables to reduce the constraint error, while the error size is greater than a predetermined threshold and there exist non-zero increments.

11. The method of claim 10, wherein if the error magnitude is still too high, the method further comprises selecting and removing a constraint from said group of constraints, and applying the scaled Jacobian method to the remaining constraints to reduce the error magnitude.

12. The method of claim 10, further comprising:
finding, for all constraints in the group, a constraint with a highest error; and
normalizing the other constraint errors to the constraint with the highest error by calculating a multiplier for each variable in the constraints based on a relative error size of each constraint, wherein the highest error has a multiplier weight of one.

13. The method of claim 10, wherein calculating a variable increment size that reduces a constraint error comprises:
selecting active variables for which error reduction will be calculated;
initializing an increment step for an active variable;
determining if a current increment value will increase or decrease the error for an active variable;
halving the increment size, if the current increment does not decrease the error, or using the current increment as a step direction for the corresponding active variable; and
if at least one variable causes the error to decrease, using a Jacobian vector for all variables that decrease the error to reduce the constraint error.

14. The method of claim 13, wherein selecting variables to be active further comprises:
initializing a contribution to error reduction for each constraint variable by using the current increment value;
determining a magnitude of change in the constraint error for all variables; and
marking a variable with a least contribution as being inactive, wherein a number of degrees-of-freedom for the variables is reduced by the number of degrees-of-freedom for the inactivated variable,
wherein the steps of determining a magnitude of change and marking a variable are performed while the number of degrees-of-freedom for the variables is greater than the number of degrees-of-freedom for the constraints.

15. A non-transitory program storage device readable by a computer, tangibly embodying a program of instructions executed by the computer to perform the method steps for solving sketching constraints, the method comprising:
isolating a set of sketching constraints into groups of constraints with related variables;
checking a magnitude of error in a group of constraints; and
reducing the error magnitude by applying a scaled Jacobian method, if the error magnitude is too high,
wherein if the error magnitude is still too high after applying the scaled Jacobian method, selecting and removing a constraint from said group of constraints.

16. The computer readable program storage device of claim 15, the method further comprising, after removing a constraint, applying the scaled Jacobian method to the remaining constraints to reduce the error magnitude.

17. The computer readable program storage device of claim 15, wherein selecting a constraint to be removed from the group of constraints includes at least one of determining which constraints have a highest error and choosing those constraints within a predetermined range of the highest error, selecting those constraints that share a variable with a constraint with the highest error, and using a weighting criteria to eliminate constraints.

18. The computer readable program storage device of claim 15, wherein applying a scaled Jacobian method comprises:
finding, for all constraints in the group, a constraint with a highest error;
normalizing the other constraint errors to the constraint with the highest error by calculating a multiplier for each variable in the constraints based on a relative error size of each constraint, wherein the highest error has a multiplier weight of one;
initializing an increment size for all variables; and
calculating a variable increment size that reduces a constraint error and determining a scaling factor from a multiple of that increment that maximizes error reduction, while the error size is greater than a predetermined threshold and there exist non-zero increments.

19. The computer readable program storage device of claim 18, the method further comprising:
applying the scaling factor to a Jacobian vector of the constraint variables to determine a greatest error that can be eliminated; and
applying the Jacobian vector to the variables to reduce the constraint error.

20. The computer readable program storage device of claim 18, wherein calculating a variable increment size that reduces a constraint error comprises:
selecting active variables for which error reduction will be calculated;
initializing an increment step for an active variable;
determining if a current increment value will increase or decrease the error for an active variable; and
halving the increment size, if the current increment does not decrease the error, or using the current increment as a step direction for the corresponding active variable.

21. The computer readable program storage device of claim 20, wherein calculating how much a constraint error changes for a given incremental value comprises using a scaled error approach.

22. The computer readable program storage device of claim 20, the method further comprising, if at least one variable causes the error to decrease, using a Jacobian vector for all variables that decrease the error to reduce the constraint error.

23. The computer readable program storage device of claim 20, wherein selecting variables to be active further comprises:
initializing a contribution to error reduction for each constraint variable by using the current increment value;
determining a magnitude of change in the constraint error for all variables; and
marking a variable with a least contribution as being inactive, wherein a number of degrees-of-freedom for the variables is reduced by the number of degrees-of-freedom for the inactivated variable,
wherein the steps of determining a magnitude of change and marking a variable are performed while the number of degrees-of-freedom for the variables is greater than the number of degrees-of-freedom for the constraints.
